(19) United States
(12) Patent Application Publication
(10) Pub. No.: US 2025/0128837 A1
(43) Pub. Date: Apr. 24, 2025

(54) DRONE AND METHOD OF NEUTRALIZING ILLEGAL DRONE PERFORMED BY DRONE

(71) Applicant: Electronics and Telecommunications Research Institute, Daejeon (KR)

(72) Inventors: Jeonggi YANG, Sejong-si (KR); Uihwan CHOI, Daejeon (KR)

(21) Appl. No.: 18/924,279

(22) Filed: Oct. 23, 2024

(30) Foreign Application Priority Data
Oct. 23, 2023 (KR) 10-2023-0142051
Oct. 17, 2024 (KR) 10-2024-0142080

(51) Int. Cl. B64U 70/20; B64U 10/10; B64U 20/80; B64U 101/16

(52) U.S. Cl. CPC B64U 70/20; B64U 10/10; B64U 20/80; B64U 2101/16

(57) ABSTRACT

Provided are a drone and a method of neutralizing an illegal drone performed by the drone. The method includes, by interoperating with a ground management device installed in a protection zone, detecting an illegal drone flying in the protection zone without permission, tracking the illegal drone having mobility using a detection sensor mounted on the drone at the same time as the illegal drone is detected, and by performing a direct collision on a center frame of the tracked illegal drone, capturing the illegal drone on which the direct collision is performed.

### CROSS-REFERENCE TO RELATED APPLICATIONS

This application claims the benefit of Korean Patent Application No. 10-2024-0142080, filed on Oct. 17, 2024, and Korean Patent Application No. 10-2023-0142051, filed on Oct. 23, 2023, in the Korean Intellectual Property Office, the entire disclosure of which is incorporated herein by reference for all purposes.

### BACKGROUND

### 1. Field of the Invention

One or more embodiments relate to a drone and a method of neutralizing an illegal drone performed by the drone.

### 2. Description of the Related Art

Recently, interest in an anti-drone system that is available in an urban area is increasing as the two countries use a drone to strike the capital in the war between Ukraine and Russia. An anti-drone system may be largely divided into functions such as detection, identification, tracking, and neutralization. Functions such as detection, identification, and tracking of an anti-drone system may be introduced to a military system for military purposes such as drone detection radar, electro-optical (EO)/infrared (IR), etc., but a neutralization function of an anti-drone system may not be introduced.

Specifically, a drone neutralization system developed for military purposes such as an anti-drone missile, a multiple rocket launcher, etc., assumes a hard kill of a drone, but if a drone is hard killed in an urban area, the drone may crash and cause damage to civilians. Therefore, to neutralize a drone in an urban area, a soft kill means is essential, and it is necessary to develop a drone neutralization means for this.

Here, a drone equipped with Jammer or Net-Gun is mentioned as a candidate for a drone neutralization means that may be used in an urban area. However, Jammer has a disadvantage of not being able to cope with an onboard sensor-based autonomous flying drone that is being developed recently. This is because an onboard sensor-based autonomous flying drone does not receive a pilot signal when a destination is input and may fly by tracking a target with an image without a global positioning system (GPS) signal. In addition, an onboard sensor-based autonomous flying drone has different frequencies used for each drone, so it is not easy to find and jam the frequencies that are being used.

Additionally, a drone equipped with Net-Gun has a disadvantage that a quadcopter flies at a low speed, and the accuracy rate of Net-Gun for a fixed-wing aircraft is not high. In particular, a drone equipped with Net-Gun has a problem that the accuracy rate is significantly low when an illegal drone or a target aircraft executes an evasion flight, and a plurality of Net-Gun drones must be dispatched depending on whether a soft kill fails or not.

### SUMMARY

According to an aspect, there is provided a method of neutralizing an illegal drone performed by a drone, the method including, by interoperating with a ground management device installed in a protection zone, detecting an illegal drone flying in the protection zone without permission, tracking the illegal drone having mobility using a detection sensor mounted on the drone at the same time as the illegal drone is detected, and by performing a direct collision on a center frame of the tracked illegal drone, capturing the illegal drone on which the direct collision is performed.

The tracking of the illegal drone may include monitoring the illegal drone having mobility using the detection sensor mounted on the drone, in which the detection sensor may include at least one of an event camera configured to detect a pixel activated by a change in light and a color sensor configured to detect a color of the illegal drone according to the change in light.

The tracking of the illegal drone may include, using an optical device of the event camera mounted on the drone, detecting a pixel activated on a screen of the event camera by light exposed to the optical device and tracking a moving direction of the illegal drone by detecting the color of the illegal drone by the detected pixel, using the color sensor.

The capturing of the illegal drone may include determining a moving path of the illegal drone according to the tracked moving direction of the illegal drone and performing the direct collision on the center frame of the tracked illegal drone using the moving path of the illegal drone.

The capturing of the illegal drone may include neutralizing a movement of the illegal drone by combining the drone with a predetermined area of the illegal drone according to shape transformation of the drone that occurs simultaneously with the direct collision with the center frame of the tracked illegal drone and automatically ejecting a dropping means inserted into a lower end of the drone as the drone directly collides with the center frame of the tracked illegal drone.

The capturing of the illegal drone may include capturing the neutralized movement of the illegal drone by considering a position of an obstacle existing in a predetermined radius of the protection zone centered on a position where the illegal drone is captured.

The neutralizing of the movement of the illegal drone may include causing the shape transformation of the drone to occur by axial rotation of a grasper fixed to a caught device of a mechanical trigger means responding to a direct collision with the illegal drone, from a center frame of the drone by the direct collision, and neutralizing the movement of the illegal drone that collides with the mechanical trigger means using a claw of the grasper according to the shape transformation of the drone.

According to another aspect, there is provided a drone including a center frame having a missile shape, a mechanical trigger means disposed on an upper end of the center frame and responding to a collision with an illegal drone, a grasper disposed on a side surface of the center frame and fixed by a caught device of the mechanical trigger means, and a dropping means disposed on a lower end of the center frame and configured to crash the illegal drone to ground.

The mechanical trigger means may include a cover disposed on the upper end of the center frame and configured in a dome shape, the caught device that is perpendicularly combined with a support of the cover and configured in a dagger shape having a predetermined cross-section, and a central axis configured in a screw-line shape so that the caught device combined with the grasper is rotated in one direction by an impact applied to the cover.

The grasper may include a side plate formed as a partial frame of the center frame and disposed on the side surface of the center frame at a predetermined interval by a condensed spring, a step plate that is vertically combined with a lower end of the side plate, and a claw disposed at an end of the step plate and configured to fix the illegal drone that collides with the mechanical trigger means.

The grasper may operate by recoil of the condensed spring as a combination with the caught device is released by an impact applied to the mechanical trigger means when the mechanical trigger means collides with the illegal drone.

The grasper may operate in a form of surrounding the mechanical trigger means by being axially rotated by the recoil of the condensed spring with an upper end of the side plate as a rotation axis.

The grasper may be configured to neutralize a movement of the illegal drone that collides with the mechanical trigger means using the claw fixed in a form of surrounding the mechanical trigger means.

The dropping means may be ejected from the lower end of the center frame when the movement of the illegal drone is neutralized.

According to still another aspect, there is provided a drone including a processor, in which the processor is configured to, by interoperating with a ground management device installed in a protection zone, detect an illegal drone flying in the protection zone without permission, track the illegal drone having mobility using a detection sensor mounted on the drone at the same time as the illegal drone is detected, and by performing a direct collision on a center frame of the tracked illegal drone, capture the illegal drone on which the direct collision is performed.

The processor may be configured to monitor the illegal drone using a detection sensor including an event camera configured to detect a pixel activated by a change in light and a color sensor configured to detect a color of the illegal drone according to the change in light.

The processor may be configured to determine a moving path of the illegal drone according to a moving direction of the illegal drone and perform the direct collision on the center frame of the tracked illegal drone using the moving path of the illegal drone.

The processor may be configured to neutralize a movement of the illegal drone by combining the drone with a predetermined area of the illegal drone according to shape transformation of the drone that occurs simultaneously with the direct collision with the center frame of the tracked illegal drone.

The processor may be configured to capture the neutralized movement of the illegal drone by considering a position of an obstacle existing in a predetermined radius of the protection zone centered on a position where the illegal drone is captured.

The processor may be configured to cause the shape transformation of the drone to occur by axial rotation of a grasper fixed to a caught device of a mechanical trigger means responding to a direct collision with the illegal drone, from a center frame of the drone by the direct collision, and neutralize the movement of the illegal drone that collides with the mechanical trigger means using a claw of the grasper according to the shape transformation of the drone.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating the overall operation of a drone that neutralizes an illegal drone, according to an embodiment;

FIG. 2 is a diagram illustrating a state in which the exterior of a drone is transformed, according to an embodiment;

FIGS. 3A and 3B are diagrams illustrating a hardware structure of a drone, according to an embodiment;

FIG. 4 is a diagram illustrating a detailed operation of an illegal drone, according to an embodiment; and

FIG. 5 is a flowchart illustrating a method of neutralizing an illegal drone performed by a drone, according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions on the embodiments may be applicable to the following embodiments and thus, duplicated descriptions will be omitted for conciseness.

A method of neutralizing an illegal drone described herein is a method performed by a drone that collides with the illegal drone at high speed and then captures the illegal drone. The method may include a contact neutralization method to capture an illegal drone, a contact method to neutralize an illegal drone, and a landing technique that captures an illegal drone and then moves to a safe place.

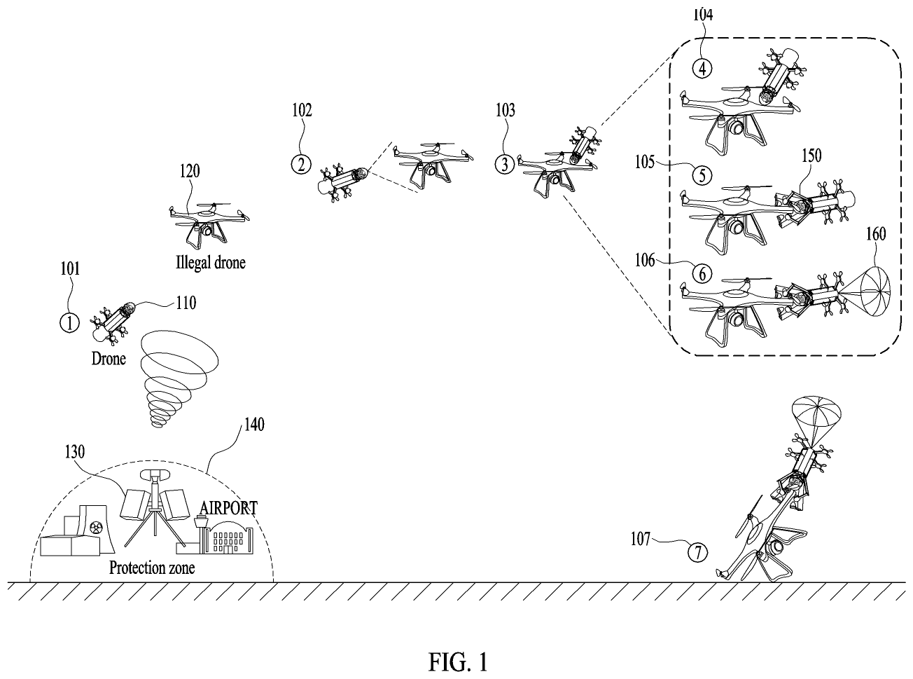

FIG. 1 is a diagram illustrating the overall operation of a drone that neutralizes an illegal drone, according to an embodiment.

Referring to FIG. 1, a drone 110 may detect and track an illegal drone 120 flying in a preset protection zone 140 without permission, collide with the illegal drone 120 at high speed, and then capture the illegal drone 120 that is neutralized by the collision. The drone 110 may analyze various environments and situations that may occur in the protection zone 140 by interoperating with a ground management device 130 disposed in the protection zone 140. In addition, the drone 110 may organically operate by intelligently combining detection, tracking, determination, and neutralization technologies that are appropriate to the analysis result.

Here, the drone 110 may be a drone that performs a soft kill that collides with the illegal drone 120 determined to be dangerous and neutralizes and retrieves the illegal drone 120. The soft kill performed by the drone 110 may be mainly operated through four stages. The four stages may be as follows.

The four stages may include \textcircled{1} Linkage stage with illegal drone detection/identification/tracking radar 101, \textcircled{2} Illegal drone detection and collision attempt stage 102, \textcircled{3} Neutralization means operating stage after a direct collision 103, and \textcircled{4} Safe landing stage 107.

\textcircled{1} the Linkage Stage with Illegal Drone Detection/Identification/Tracking Radar 101

The ground management device 130 may detect the illegal drone 120 flying in the protection zone 140 without permission, using radar. The ground management device 130 may transmit sortie information to the drone 110 at the same time as the illegal drone 120 is detected. The drone 110 may move to a position where the illegal drone 120 is detected as soon as the sortie information is received. Specifically, the drone 110 may detect the illegal drone 120 flying in the protection zone 140 without permission, using the radar of the ground management device 130 installed in the protection zone 140 set to defend a certain target.

Here, the protection zone 140 may be a zone where unnecessary access is prohibited and entry is restricted by setting a predetermined range in a place that is necessary to protect a certain target, such as a national secret or an important facility. For example, the certain target may correspond to a major national facility including a nuclear power plant, an airport, the Blue House, a military facility, etc., and may further include various buildings such as a private home, an office, a school, etc. The protection zone 140 may be set to a predetermined radius, based on a position of the certain target.

The drone 110 may automatically launch into the sky according to the sortie information and then perform a flight to move to a position where the illegal drone 120 is detected, that is, a coordinate of the illegal drone 120, by interoperating with radar disposed on the ground. The drone 110 may perform a high-speed flight to chase and move more quickly to the position of the illegal drone 120. For example, a center frame of the drone 110 may include components of a racing drone capable of high-speed flight.

The drone 110 may obtain a surveillance image including at least one target drone flying in the protection zone 140 while moving to the position of the illegal drone 120. The drone 110 may label at least one target drone included in the surveillance image and determine whether the labeled target drone is permitted to fly. The drone 110 may detect, among target drones, the illegal drone 120 flying in the protection zone 140 without permission by considering whether the target drones are permitted to fly. The drone 110 may improve the identification rate of the illegal drone 120 through the radar disposed on the ground by performing labeling after approaching the flying target drones according to the sortie information.

The drone 110 may track the illegal drone 120 having mobility using radar and a detection sensor mounted on the drone 110. The detection sensor may include an event camera that detects a pixel activated by a change in light and a color sensor that detects a color (red, green, and blue (RGB)) of the illegal drone 120 by the change in light.

The drone 110 may detect, using an optical device of the event camera mounted on the drone 110, a pixel activated on a screen of the event camera by light exposed to the optical device. The drone 110 may track a position of the illegal drone 120 flying in the protection zone 140 by detecting the color of the illegal drone 120 by the detected pixel, using the color sensor.

### \textcircled{2} the Illegal Drone Detection and Collision Attempt Stage 102

The drone 110 may change a flight point of the drone 110 to fly in a predetermined accessible range to collide with the tracked illegal drone 120. The drone 110 may determine a collision point of the drone 110 using a moving path according to a moving direction of the illegal drone 120. The drone 110 may change a flight path of the drone 110 in response to the collision point of the drone 110.

\textcircled{3} the Neutralization Means Operating Stage after a Direct Collision 103

The drone 110 may neutralize and retrieve the illegal drone 120 by performing a detailed process through operations 104 to 107 after the flight path of the drone 110 is changed.

In operation 104, when the drone 110 enters a predetermined range where a collision with the illegal drone 120 is possible according to the changed flight path, a direct collision with the illegal drone 120 may be performed.

In operation 105, when the drone 110 succeeds in the direct collision with the illegal drone 120, a mechanical trigger may be activated. The mechanical trigger may indicate that the exterior of the drone 110, that is, the shape of the drone 110, is changed. The drone 110 may capture the illegal drone 120 by applying mechanical damage to the illegal drone 120 using a neutralizing means 150 of the drone 110 according to the mechanical trigger. The mechanical damage may be an act of seizing a power unit of the illegal drone 120.

More specifically, as the direct collision with the illegal drone 120 is successful and the mechanical trigger operates at the same time, the neutralizing means 150 in the form of a claw may be disposed on the upper end of the drone 110. The drone 110 may neutralize a movement of the illegal drone 120 by combining with a certain area of the illegal drone 120 that directly collided with the drone 110, that is, the power unit of the illegal drone 120, using the neutralizing means 150 that is mechanically triggered.

In operation 106, the drone 110 may eject a dropping means 160 in a state in which the illegal drone 120 is neutralized and captured.

### \textcircled{4} the Safe Landing Stage 107

The drone 110 may seize the power unit of the illegal drone 120 using the neutralizing means 150 and then land at a safe place by ejecting the dropping means 160 inserted into the lower end of the drone 110. The drone 110 may identify a position of an obstacle existing in a predetermined radius of the protection zone 140 centered on the position where the illegal drone 120 is captured. The drone 110 may land on the ground together with the illegal drone 120 while avoiding the identified position of the obstacle.

The drone 110 may ensure a safe landing by performing a quick response and soft kill on the illegal drone 120 through each stage described above. That is, the center frame of the drone 110 may be designed to respond to the illegal drone 120 flying without permission, quickly eliminate the threat of the illegal drone 120, and protect public safety. In particular, the drone 110 may safely capture the illegal drone 120 without destroying the illegal drone 120 using soft kill technology to neutralize the illegal drone 120 by directly colliding with the illegal drone 120.

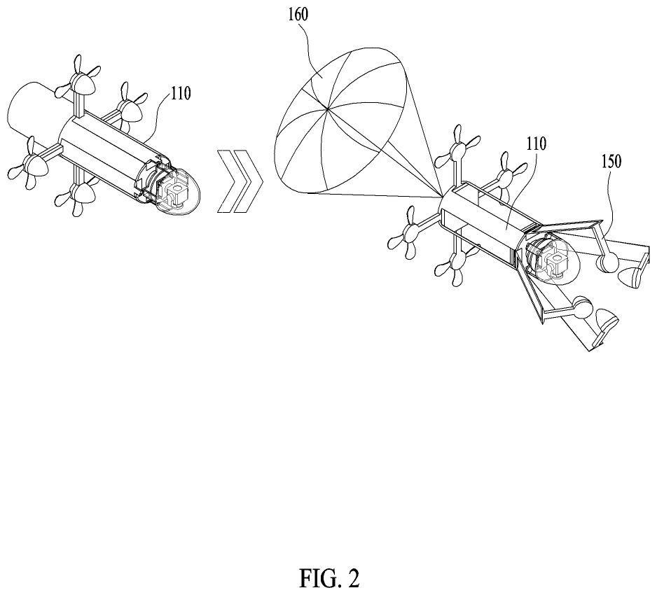

FIG. 2 is a diagram illustrating a state in which the exterior of a drone is transformed, according to an embodiment.

Referring to FIG. 2, the drone 110 may directly collide with an illegal drone at high speed and may neutralize and capture the illegal drone using the neutralizing means 150. After neutralizing and capturing the illegal drone, the drone 110 may induce a safe landing by ejecting the dropping means 160. When the drone 110 lands using the dropping means 160, secondary damage caused by fragments of a center frame of the illegal drone may be minimized by falling at a low speed. The drone 110 may also be reused as the impact applied to the center frame due to a low-speed fall is minimized, and the resulting cost effect may be maximized.

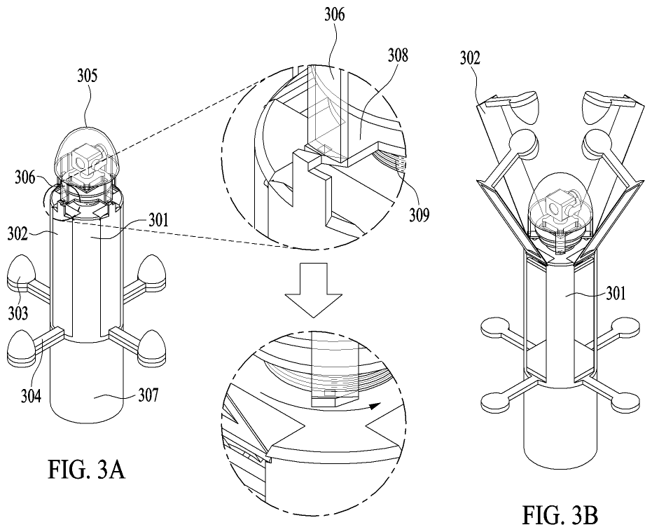

FIGS. 3A and 3B are diagrams illustrating a hardware structure of a drone, according to an embodiment.

Referring to FIGS. 3A and 3B, the drone 110 may be equipment capable of directly colliding with an illegal drone at high speed and may neutralize and capture the illegal drone at the same time. The drone 110 may minimize secondary damage that may occur in a process of capturing the illegal drone through landing using a dropping means and may more safely retrieve the neutralized and captured illegal drone.

Referring to FIG. 3A, the drone 110 may include a center frame 301, a mechanical trigger means, a grasper, and a dropping means 307.
\textcircled{1} The center frame 301 may have a missile shape that may minimize air resistance aerodynamically and may be a basic body of the drone 110.
\textcircled{2} The mechanical trigger means may be disposed on the upper end of the center frame 301. The mechanical trigger means may be a tool that automatically generates a mechanical motion in response to a collision with an illegal drone. More specifically, the mechanical trigger means may include a cover 305, a support 306 of the cover 305, a caught device 308, and a central axis 309.

The cover 305 may be disposed on the upper end of the center frame 301 and configured in a dome shape. Here, the cover 305 may be a trigger that takes out the caught device 308 when a collision occurs. The cover 305 may be implemented with a transparent material, and when the cover 305 is implemented with a transparent material, a detection sensor may be disposed inside the cover 305, thereby minimizing damage to a sensor due to a collision.

The support 306 of the cover 305 may be fixed vertically to the cover 305 and in contact with the caught device 308. The caught device 308 may be perpendicularly combined with the support 306 of the cover 305 and configured in a dagger shape having a predetermined cross-section.

The central axis 309 may be configured in a screw-line shape so that the caught device 308 combined with the grasper is rotated in one direction by the impact applied to the cover 305. The central axis 309 may be a device that induces the caught device 308 to rotate in one direction in response to the collision with the illegal drone.
\textcircled{3} A plurality of graspers may be disposed on the side surface of the center frame 301. The graspers may include side plates 302, step plates 303, and claws 304.

The side plates 302 may be plates formed as partial frames of the center frame 301 and disposed on the side surface of the center frame 301 in plurality at a predetermined interval by a condensed spring. The step plates 303 may be vertically combined with the lower end of each of the side plates 302. The claws 304 may be tools for stopping a movement of the illegal drone that collides with a mechanical trigger means by being disposed at the ends of the step plates 303. The graspers may be internally connected to the condensed spring and may not operate by being combined with the caught device 308.

When the mechanical trigger means collides with the illegal drone, the exterior of the graspers may be transformed by the recoil of the condensed spring as a combination with the caught device 308 is released by the impact applied to the mechanical trigger means. Specifically, the graspers may be devices fixed by the caught device 308 of the mechanical trigger means, and the shape of the graspers may be changed due to the collision with the illegal drone. Depending on the operation mode of the drone 110, the graspers may be formed as some parts of the center frame 301 or may be transformed into a physical structure to capture the illegal drone.

The graspers may be pushed sideways while the mechanical trigger means is pressed, and the caught device 308 caught to the central axis 309 is pressed. The graspers may be completely pulled sideways, and the structure of the graspers may be transformed due to the condensed spring.

When the graspers are transformed into a physical structure, as shown in FIG. 3B, the graspers may be transformed into a structure that grabs an object or unfolds to neutralize the movement of the illegal drone. For example, the graspers may be transformed into a structure that may grab an object as if the graspers protrude from the center frame 301 by the impact with the illegal drone. The physical structure of the graspers may be formed in a claw shape to fix the illegal drone by protruding from the center frame 301.

The graspers may be axially rotated by the recoil of the condensed spring with the upper end of the side plates 302 as a rotation axis, thereby transforming the exterior of the drone 110 into a form of surrounding the mechanical trigger means. As the exterior of the drone 110 is transformed, the drone 110 may neutralize and capture the movement of the illegal drone that collides with the mechanical trigger means using the claws 304 fixed in a form of surrounding the mechanical trigger means.

Eventually, the graspers may be configured as means to seize and neutralize the illegal drone by transforming the frame itself forming the center frame 301 to capture an illegal drone that is larger than the drone 110 regardless of the size of the illegal drone.

The dropping means 307 may be disposed on the lower end of the center frame 301. The dropping means 307 may be a structure that is ejected from the lower end of the center frame 301 by neutralizing the movement of the illegal drone. The dropping means 307 may be a device that induces the drone 110 that captures the illegal drone to descend above the ground. When the movement of the illegal drone is neutralized, the dropping means 307 may be ejected from the lower end of the center frame 301 and land the drone 110 from the air to the ground. The drone 110 may induce the illegal drone to be retrieved more safely by the physical structure described above.

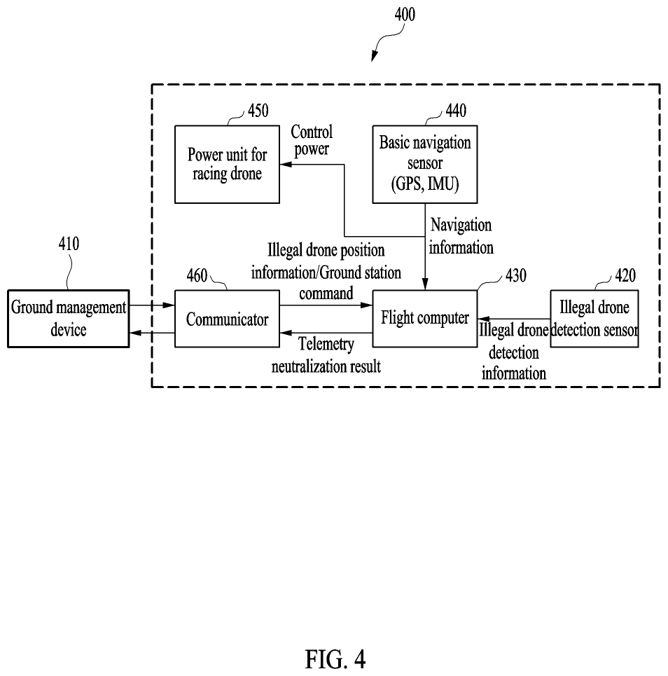

FIG. 4 is a diagram illustrating a detailed operation of an illegal drone, according to an embodiment.

Referring to FIG. 4, the drone 110 is a navigation element to track a flight of the drone 110 and an illegal drone and may include an illegal drone detection sensor 420, a flight computer 430, a basic navigation sensor 440, a power unit for a racing drone 450, and a communicator 460.

The illegal drone detection sensor 420 may generate illegal drone detection information about the illegal drone using a detection sensor including at least one of an event camera and a color sensor. The illegal drone detection sensor 420 may provide the illegal drone detection information to the flight computer 430.

The basic navigation sensor 440 may be a global positioning system (GPS), an inertial measurement unit (IMU), etc. The basic navigation sensor 440 may interoperate with the flight computer 430 and provide navigation information to the flight computer 430.

The communicator 460 may be equipment to communicate with a ground management device 410 to detect, identify, and track the illegal drone. The communicator 460 may receive, from the flight computer 430, sortie information including position information of the illegal drone and a ground station command. The communicator 460 may provide the sortie information transmitted from the ground management device 410 to the flight computer 430.

The flight computer 430 may interoperate with the illegal drone detection sensor 420, the basic navigation sensor 440, and the communicator 460.

The flight computer 430 may receive the illegal drone detection information from the basic navigation sensor 440 and receive the navigation information from the basic navigation sensor 440. The navigation information may be a coordinate of the illegal drone. The flight computer 430 may generate a telemetry neutralization result regarding the illegal drone, based on the illegal drone detection information and the navigation information. The flight computer 430 may transmit the telemetry neutralization result to the communicator 460, and the communicator 460 may transmit the telemetry neutralization result to the ground management device 410.

The flight computer 430 may generate a command to control the power of the power unit for the racing drone 450, based on the sortie information, the illegal drone detection information, and the navigation information. The flight computer 430 may provide the generated command to the power unit for the racing drone 450.

The power unit for the racing drone 450 may control power of the drone 110 according to the command received from the flight computer 430.

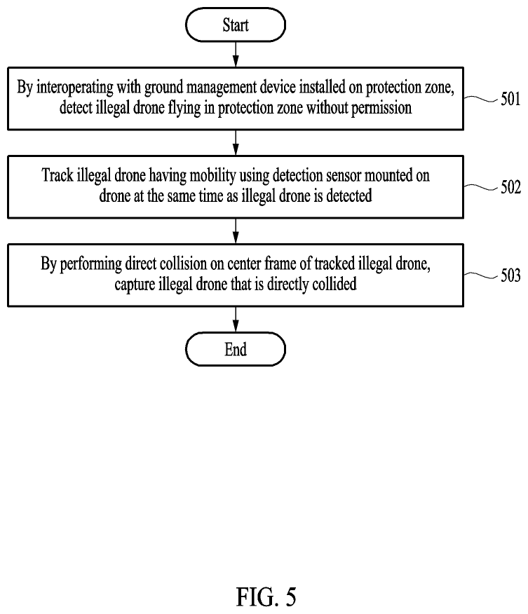

FIG. 5 is a flowchart illustrating a method of neutralizing an illegal drone performed by a drone, according to an embodiment.

In operation 501, the drone 110 may communicate with a ground management device disposed in a protection zone on the ground. The ground management device may detect a target drone flying in the protection zone without permission, using radar installed in the protection zone set to defend a certain target. When the target drone is detected, the ground management device may transmit, to the drone 110, sortie information indicating that the target drone is detected. Here, the target drone may be a drone of which a flight is permitted or a drone of which a flight is not permitted. The ground management device may sense and detect all drones flying over the protection zone, using laser.

In operation 502, the drone 110 may move to a point where the target drone is detected at the same time the sortie information is received from the ground management device. The drone 110 may obtain a surveillance image including at least one target drone flying in the protection zone centered on the point the drone 110 moved to. The drone 110 may label at least one target drone included in the surveillance image. The drone 110 may determine whether the labeled target drone is permitted to fly.

The drone 110 may transmit detection release information to the ground management device and move to a waiting point when the target drone is permitted to fly. The detection release information may be information indicating that a drone that is currently flying in the protection zone is not an enemy.

When the target drone is not permitted to fly, the drone 110 may determine the target drone that is not permitted to fly to be the illegal drone and track the illegal drone. More specifically, when the illegal drone is detected, the drone 110 may track the illegal drone having mobility using radar and a detection sensor mounted on the drone 110.

The drone 110 may track the illegal drone using the detection sensor mounted on a head of the drone 110. The detection sensor may include an event camera and a color sensor. The event camera may be a camera that detects a pixel activated by a change in light. The color sensor may be a sensor that detects a color of the illegal drone by the change in light.

The drone 110 may detect, using an optical device of the event camera, a pixel activated on a screen of the event camera by light exposed to the optical device. The drone 110 may then track a moving direction of the illegal drone by detecting the color of the pixel detected by the event camera, that is, the pixel activated on the screen of the event camera, using the color sensor.

In operation 503, the drone 110 may perform a direct collision on a center frame of the tracked illegal drone and capture the illegal drone that directly collided. Specifically, the drone 110 may identify a second moving direction of the illegal drone after a certain period of time, based on a first moving direction of the illegal drone tracked in operation 502.

The drone 110 may determine the moving path of the illegal drone, based on the first moving direction of the illegal drone and the second moving direction of the illegal drone. The drone 110 may determine a collision point for the direct collision with the illegal drone in response to the determined moving path of the illegal drone. That is, the drone 110 may determine an expected flight point of the illegal drone, based on the moving path of the illegal drone. The drone 110 may determine the collision point of the drone 110 using navigation information of the drone 110 and the expected flight point of the illegal drone. The drone 110 may change a flight path of the drone 110 in response to the collision point of the drone 110.

The drone 110 may perform a direct collision on the illegal drone to neutralize the illegal drone when the illegal drone enters a predetermined range centered on the collision point of the drone 110.

When the direct collision is successful, the drone 110 may capture the illegal drone by directly damaging the illegal drone according to the mechanically and automatically changed exterior of the drone 110. Specifically, a grasper mounted on the upper end of the drone 110 may be mechanically triggered at the same time as the upper end of the drone 110 collides with the center frame of the illegal drone or some frames of the illegal drone. The drone 110 may neutralize a movement of the illegal drone by combining the drone 110 with a certain area of the illegal drone that directly collided, using the mechanically triggered grasper. When the movement of the illegal drone is neutralized, the drone 110 may capture the neutralized movement of the illegal drone by ejecting a dropping means inserted into the lower end of the drone 110. Here, the dropping means may be automatically ejected from the lower end of the drone 110 as the drone 110 directly collides with the illegal drone.

The drone 110 may then determine whether an obstacle exists on the ground such that the drone 110 that captures the illegal drone in a predetermined radius of the protection zone may land. The obstacle may include a building, a road, a sidewalk, a person, a car, etc., positioned in the protection zone or in a predetermined radius of the protection zone. When the obstacle exists, the drone 110 may identify the position of the obstacle and land on the ground while avoiding the identified obstacle.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. A method of neutralizing an illegal drone performed by a drone, the method comprising:
by interoperating with a ground management device installed in a protection zone, detecting an illegal drone flying in the protection zone without permission;
tracking the illegal drone having mobility using a detection sensor mounted on the drone at the same time as the illegal drone is detected; and
by performing a direct collision on a center frame of the tracked illegal drone, capturing the illegal drone on which the direct collision is performed.

2. The method of claim 1, wherein the tracking of the illegal drone comprises monitoring the illegal drone having mobility using the detection sensor mounted on the drone,
wherein the detection sensor comprises at least one of an event camera configured to detect a pixel activated by a change in light and a color sensor configured to detect a color (red, green, and blue (RGB)) of the illegal drone according to the change in light.

3. The method of claim 2, wherein the tracking of the illegal drone comprises:
using an optical device of the event camera mounted on the drone, detecting a pixel activated on a screen of the event camera by light exposed to the optical device; and
tracking a moving direction of the illegal drone by detecting the color of the illegal drone by the detected pixel, using the color sensor.

4. The method of claim 3, wherein the capturing of the illegal drone comprises:
determining a moving path of the illegal drone according to the tracked moving direction of the illegal drone; and
performing the direct collision on the center frame of the tracked illegal drone using the moving path of the illegal drone.

5. The method of claim 4, wherein the capturing of the illegal drone comprises:
neutralizing a movement of the illegal drone by combining the drone with a predetermined area of the illegal drone according to shape transformation of the drone that occurs simultaneously with the direct collision with the center frame of the tracked illegal drone; and
automatically ejecting a dropping means inserted into a lower end of the drone as the drone directly collides with the center frame of the tracked illegal drone.

6. The method of claim 5, wherein the capturing of the illegal drone comprises capturing the neutralized movement of the illegal drone by considering a position of an obstacle existing in a predetermined radius of the protection zone centered on a position where the illegal drone is captured.

7. The method of claim 5, wherein the neutralizing of the movement of the illegal drone comprises:
causing the shape transformation of the drone to occur by axial rotation of a grasper fixed to a caught device of a mechanical trigger means responding to a direct collision with the illegal drone, from a center frame of the drone by the direct collision; and
neutralizing the movement of the illegal drone that collides with the mechanical trigger means using a claw of the grasper according to the shape transformation of the drone.

8. A drone comprising:
a center frame having a missile shape;
a mechanical trigger means disposed on an upper end of the center frame and responding to a collision with an illegal drone;
a grasper disposed on a side surface of the center frame and fixed by a caught device of the mechanical trigger means; and
a dropping means disposed on a lower end of the center frame and configured to crash the drone to ground.

9. The drone of claim 8, wherein the mechanical trigger means comprises:
a cover disposed on the upper end of the center frame and configured in a dome shape;
the caught device that is perpendicularly combined with a support of the cover and configured in a dagger shape having a predetermined cross-section; and
a central axis configured in a screw-line shape so that the caught device combined with the grasper is rotated in one direction by an impact applied to the cover.

10. The drone of claim 8, wherein the grasper comprises:
a side plate formed as a partial frame of the center frame and disposed on the side surface of the center frame at a predetermined interval by a condensed spring;
a step plate that is vertically combined with a lower end of the side plate; and
a claw disposed at an end of the step plate and configured to fix the illegal drone that collides with the mechanical trigger means.

11. The drone of claim 10, wherein the grasper operates by recoil of the condensed spring as a combination with the caught device is released by an impact applied to the mechanical trigger means when the mechanical trigger means collides with the illegal drone.

12. The drone of claim 11, wherein the grasper operates in a form of surrounding the mechanical trigger means by being axially rotated by the recoil of the condensed spring with an upper end of the side plate as a rotation axis.

13. The drone of claim 12, wherein the grasper is configured to neutralize a movement of the illegal drone that collides with the mechanical trigger means using the claw fixed in a form of surrounding the mechanical trigger means.

14. The drone of claim 13, wherein the dropping means is ejected from the lower end of the center frame when the movement of the illegal drone is neutralized.

15. A drone comprising:
a processor,
wherein the processor is configured to:
by interoperating with a ground management device installed in a protection zone, detect an illegal drone flying in the protection zone without permission;
track the illegal drone having mobility using a detection sensor mounted on the drone at the same time as the illegal drone is detected; and
by performing a direct collision on a center frame of the tracked illegal drone, capture the illegal drone on which the direct collision is performed.

16. The drone of claim 15, wherein the processor is configured to monitor the illegal drone using a detection sensor comprising an event camera configured to detect a pixel activated by a change in light and a color sensor configured to detect a color of the illegal drone according to the change in light.

17. The drone of claim 15, wherein the processor is configured to:
determine a moving path of the illegal drone according to a moving direction of the illegal drone; and
perform the direct collision on the center frame of the tracked illegal drone using the moving path of the illegal drone.

18. The drone of claim 15, wherein the processor is configured to neutralize a movement of the illegal drone by combining the drone with a predetermined area of the illegal drone according to shape transformation of the drone that occurs simultaneously with the direct collision with the center frame of the tracked illegal drone.

19. The drone of claim 18, wherein the processor is configured to capture the neutralized movement of the illegal drone by considering a position of an obstacle existing in a predetermined radius of the protection zone centered on a position where the illegal drone is captured.

20. The drone of claim 18, wherein the processor is configured to:
cause the shape transformation of the drone to occur by axial rotation of a grasper fixed to a caught device of a mechanical trigger means responding to a direct collision with the illegal drone, from a center frame of the drone by the direct collision; and
neutralize the movement of the illegal drone that collides with the mechanical trigger means using a claw of the grasper according to the shape transformation of the drone.
